(19) United States
(12) Patent Application Publication
(10) Pub. No.: US 2020/0012747 A1
(43) Pub. Date: Jan. 9, 2020

(54) INFORMATION PROCESSING APPARATUS AND NON-TRANSITORY COMPUTER READABLE MEDIUM STORING PROGRAM

(71) Applicant: FUJI XEROX CO., LTD., TOKYO (JP)

(72) Inventor: Atsuo KAZAMA, Kanagawa (JP)

(73) Assignee: FUJI XEROX CO., LTD., TOKYO (JP)

(21) Appl. No.: 16/452,554

(22) Filed: Jun. 26, 2019

(30) Foreign Application Priority Data
Jul. 4, 2018 (JP) 2018-127685

(51) Int. Cl. G06F 17/50; G06T 11/60; G06T 11/20

(52) U.S. Cl. CPC G06F 17/50; G06F 2217/12; G06T 11/20; G06T 11/60

(57) ABSTRACT

An information processing apparatus includes an acquisition unit that acquires recycle information regarding a recycle process of a product, a change recognition unit that recognizes change information regarding a design change of the product, and an output unit that outputs non-copable information in a case where a recycle treatment on a product after the design change is not able to be coped with by the recycle process on the basis of the recycle information and the change information.

### CROSS-REFERENCE TO RELATED APPLICATIONS

This application is based on and claims priority under 35 USC 119 from Japanese Patent Application No. 2018-127685 filed Jul. 4, 2018.

### BACKGROUND

### (i) Technical Field

The present invention relates to an information processing apparatus and a non-transitory computer readable medium storing a program.

### (ii) Related Art

JP2006-031360A discloses a production line plan supporting apparatus that includes a production simulation unit which simulates a production line operation on the basis of production line plan information, and a measures analysis unit which selects at least one facility with the production ability and/or investment expenditure to be required in order to allow a simulation result to be close to target production ability and target investment expenditure from a measures information storage unit, and outputs the facility to the production simulation unit, in which a simulation is re-performed with the facility which is selected by the measures analysis unit such that the facility with the optimum production ability and investment expenditure is automatically selected with respect to the plan of the production line.

JP2003-316860A discloses a facility personnel plan design apparatus that includes means for storing a relationship between an investment amount of quantitative extension and a production capability, means for storing a relationship between an investment amount of qualitative improvement and a production capability, and means for calculating the current cost required for product production, and that realizes a production plan for calculating an investment plan indicating the investment amount and time of quantitative extension and the investment amount and time of qualitative improvement such that a sum total of the investment amount of quantitative extension, the investment amount of qualitative improvement, and the current cost required for product production is the minimum.

JP2004-054358A discloses a capital investment evaluation system in which a conventional model using a current facility in the plant and a newly-devised model produced by increasing/decreasing the current facility are created, and production situations in respective models are simulated with a simulator on the basis of data regarding workers and a model to be produced, and data regarding a production amount. Costs required for both models are calculated on the basis of a simulation result, the costs are compared to evaluate the newly-devised model with respect to the conventional model, and thus it is determined whether or not the increase/decrease of facilities is to be performed.

JP2002-149708A discloses a product design supporting system that includes a database which stores questions, influence degrees, and the like, for each product, a product selection unit which selects a product to be evaluated from the database, an evaluation method selection unit which selects one of evaluation methods for the product to be evaluated, an evaluation execution unit which evaluates the respective components constituting the product according to the selected evaluation method, an influence degree calculation unit which calculates the degree of influence on assembly according to the result of an answer to a question, and a display device which displays the degree of influence or the like.

### SUMMARY

Meanwhile, in a case where design of a product is finished, a recycle process for recycling the product may be built. In a case where a design change is performed on the product for which the recycle process is built, a recycle treatment in the recycle process may not be performed depending on a content of the design change.

Aspects of non-limiting embodiments of the present disclosure relate to an information processing apparatus and a non-transitory computer readable medium storing a program, enabling a designer to understand whether or not a recycle treatment in a recycle process can be performed on a product after a design change in a case where the design change is performed on the product to be subjected to recycle treatment in the recycle process.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including an acquisition unit that acquires recycle information regarding a recycle process of a product; a change recognition unit that recognizes change information regarding a design change of the product; and an output unit that outputs non-copable information in a case where a recycle treatment on a product after the design change is not able to be coped with by the recycle process on the basis of the recycle information and the change information.

### BRIEF DESCRIPTION OF THE DRAWINGS

Exemplary embodiment(s) of the present invention will be described in detail based on the following figures, wherein:

FIG. 1 is a diagram illustrating an example of the entire configuration of a design system to which the present exemplary embodiment is applied;

FIG. 2 is a diagram for explaining an example of a hardware configuration of a design supporting apparatus;

FIG. 3 is a diagram illustrating an example of recycle information recorded in a recycle information DB;

FIG. 4 is a flowchart for explaining an operation of the design system;

FIGS. 5A and 5B are diagrams for explaining a wooden doll which is the current product for which a recycle line is already built;

FIGS. 6A and 6B are diagrams for explaining a wooden doll of which design is changed;

FIGS. 7A and 7B are diagrams for explaining a wooden doll of which design is changed;

FIGS. 8A and 8B are diagrams for explaining a wooden doll of which design is changed; and

FIGS. 9A and 9B are diagrams for explaining a wooden doll of which design is changed.

### DETAILED DESCRIPTION

In the present exemplary embodiment, a state is assumed in which design of a product is finished, and a recycle line for performing a recycle treatment on the product is already built. This state corresponds to a state in which a recycle treatment on the product is started, a state right before a recycle treatment on the product is started, or a state in which the product has been recycled in the past. In any case, facilities required for recycling of the product are introduced, and thus the recycle line is already built. The recycle line is a series of processes for recycling a product, and is provided with a recycle facility correlated with each process. In the following description, a process configuring the recycle line will be a recycle process in some cases. In the present exemplary embodiment, it does not matter whether or not a manufacturing line for manufacturing the product is built, but, generally, the manufacturing line is already built.

In this state, in a case where a design change is performed on the product, there is a case where the built recycling line may not cope with a recycle treatment on the product. In a case where it is recognized that the design change is performed in a range in which the current recycle line cannot cope with the design change in a stage of manufacturing the product and starting a recycle treatment on the product after the design change is completed, it is necessary to perform a design change on the product again or to rebuild a recycle line. In either case, cost and time may be required, and thus this is not preferable.

Therefore, in the present exemplary embodiment, it is possible to understand whether or not a design change performed by a designer is within a range in which a recycle treatment can be performed in a built recycle line before the design change is completed. Hereinafter, an exemplary embodiment of the present invention will be described in detail with reference to the accompanying drawings.

In description of the present exemplary embodiment, a “recycle” includes not only a so-called recycle in which a product or a component configuring the product is recycled but also a so-called reuse in which a product or a component configuring the product is reused. In other words, one or both of a facility for recycling a product or a component configuring the product and a facility for reusing a product or a component configuring the product are provided in a recycle line for performing a recycle treatment on the product.

### Entire Configuration of Design System 1

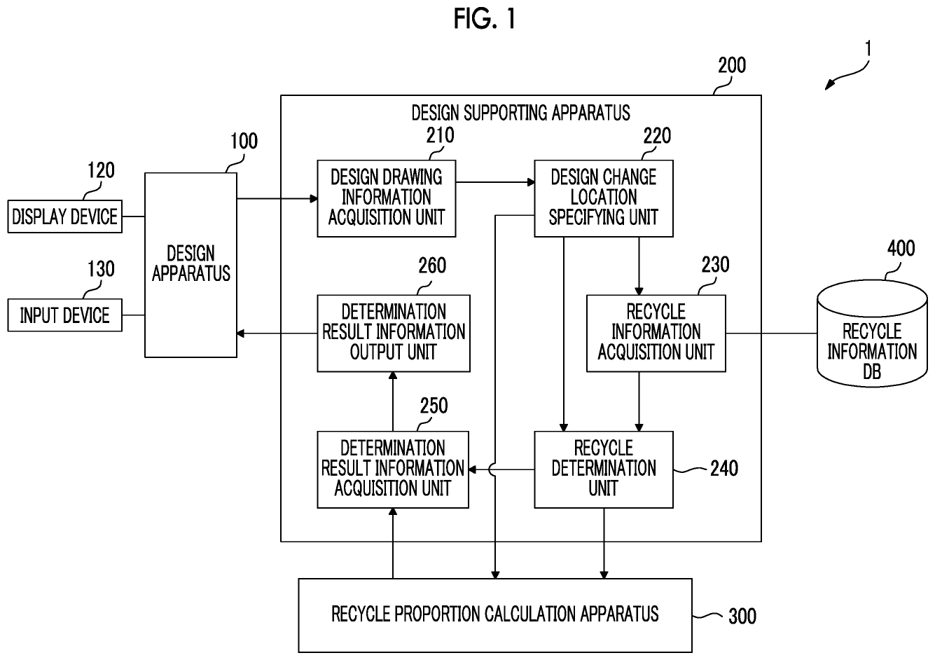

FIG. 1 is a diagram illustrating an example of the entire configuration of the design system 1 to which the present exemplary embodiment is applied.

The design system 1 is an example of an information processing apparatus, and comprises a design apparatus 100, a design supporting apparatus 200, a recycle proportion calculation apparatus 300, and a recycle information database (hereinafter, referred to as a recycle information DB) 400. FIG. 1 illustrates functional blocks with respect to the design supporting apparatus 200. Here, the design apparatus 100 is an example of a design drawing creation unit, and the recycle proportion calculation apparatus 300 is an example of a calculation unit.

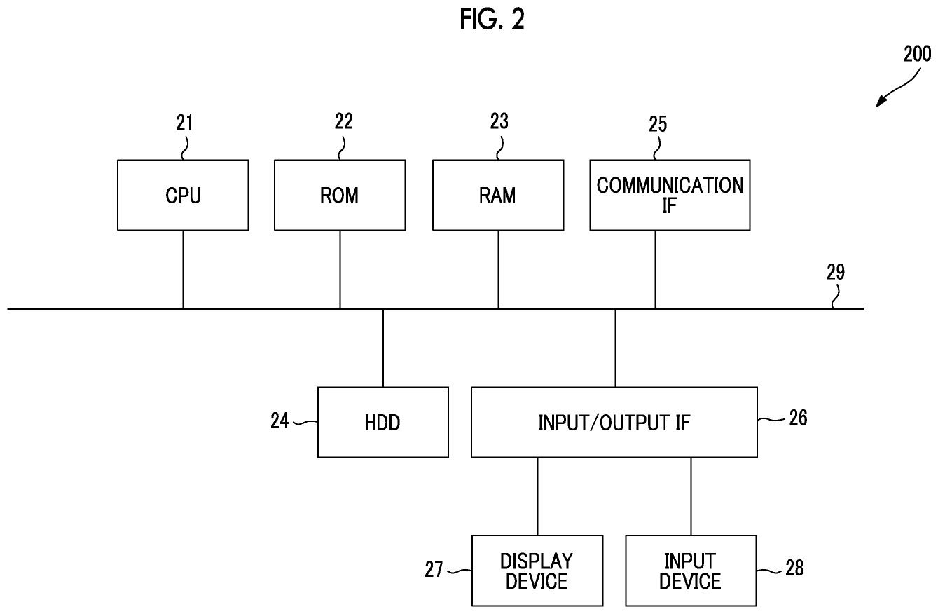

The design apparatus 100 is processing means used for a designer to design a product to be manufactured from now on. The design apparatus 100 comprises a display device 120 and an input device 130. The design apparatus 100 is configured with a computer having the same hardware configuration as that of the design supporting apparatus 200 illustrated in FIG. 2 which will be described later. Application software for causing the design apparatus 100 to function as a so-called computer-aided design (CAD) terminal is installed in the design apparatus 100.

The display device 120 of the design apparatus 100 is a display unit displaying information, such as a display using liquid crystal or organic EL. The input device 130 of the design apparatus 100 is input means which is, for example, a keyboard, a mouse, or a tablet, and is used to input information such as a command. A designer operates the input device 130 while viewing a design drawing or the like displayed on the display device 120, and designs a product to be manufactured from now on. In other words, the designer creates a design drawing of the product to be manufactured from now on by using the design apparatus 100. Here, the display device 120 is an example of a display unit.

As described above, the designer performs a design change on the product for which the recycle line is already built. Therefore, the designer creates a design drawing in which design is changed on the basis of a design drawing of the product for which the recycle line is built. Here, the product for which the recycle line is already built is referred to as the current product, and the design drawing thereof is referred to as a design drawing before a design change. A design drawing of the product of which design is changed is referred to as a design drawing after a design change.

A design drawing created in the design apparatus 100 is sent to other apparatuses (for example, the design supporting apparatus 200 and the recycle proportion calculation apparatus 300) as information. Therefore, a design drawing as information may be referred to as design drawing information. A design drawing and design drawing information may be used without being differentiated from each other.

The design supporting apparatus 200 is a processing apparatus supporting design of a product performed by the designer. The design supporting apparatus 200 is configured with a computer having a hardware configuration illustrated in FIG. 2 which will be described later. Application software for realizing a function of supporting design is installed in the design supporting apparatus 200. As details will be described later, the design supporting apparatus 200 determines whether or not a recycle treatment can be performed on a product after a design change in the recycle line on the basis of a design drawing of the product and information regarding a facility.

The recycle proportion calculation apparatus 300 is a processing apparatus which calculates a recycle proportion of a product designed in the design apparatus 100. The recycle proportion calculation apparatus 300 calculates a recycle proportion of a product in a case where it is determined that the product after a design change in the design supporting apparatus 200 can be subjected to a recycle treatment in a recycle line.

Here, the recycle proportion is an index indicating the easiness of recycling or reusing of a product, and is calculated according to a well-known method. For example, as the recycle proportion, a proportion of portions which are reused or recycled to the whole product may be used. In calculation of the recycle proportion, the number of facilities making a product or a component of the product to be reusable/recyclable, the number of times of being reusable/recyclable, or cost or treatment time required for a recycle treatment on a product may be taken into consideration. The recycle proportion calculation apparatus 300 specifies the number of facilities making a product or a component of the product reusable/recyclable, the number of times of being reusable/recyclable, or cost or treatment time required for a recycle treatment on a product, on the basis of, for example, a design drawing of the product, and calculates a recycle proportion of the product on the basis thereof.

Information regarding a recycle process or the like performed in a recycle line in which a recycle treatment is performed on the current product is recorded in the recycle information DB 400. The information regarding a recycle process or the like includes information regarding a recycle process target configuring a recycle line in which a recycle treatment is performed on a product, and information regarding a copable range in each recycle process. Herein, such information will be referred to as recycle information.

Here, the design apparatus 100, the design supporting apparatus 200, the recycle proportion calculation apparatus 300, and the recycle information DB 400 are not necessarily configured with separate apparatuses. For example, the application software for realizing a function of the design supporting apparatus 200 may be installed in the design apparatus 100. In other words, the design apparatus 100 may also be used as the design supporting apparatus 200. The application software for realizing a function of the recycle proportion calculation apparatus 300 may be installed in the design supporting apparatus 200. In other words, the design supporting apparatus 200 may also be used as the recycle proportion calculation apparatus 300. The application software for realizing a function of the recycle proportion calculation apparatus 300 may be installed in the design apparatus 100 along with the application software for realizing a function of the design supporting apparatus 200. In other words, the design apparatus 100 may also be used as the design supporting apparatus 200 and the recycle proportion calculation apparatus 300.

In FIG. 1, the design apparatus 100, the design supporting apparatus 200, and the recycle proportion calculation apparatus 300 are separately illustrated, but both of the design supporting apparatus 200 and the recycle proportion calculation apparatus 300 illustrated in FIG. 1 may be used as a design supporting apparatus. Both of the design apparatus 100 and the design supporting apparatus 200 illustrated in FIG. 1 may be used as a design supporting apparatus. All of the design apparatus 100, the design supporting apparatus 200, and the recycle proportion calculation apparatus 300 may be used as a design supporting apparatus. The above-described design supporting apparatus may further include the recycle information DB 400.

The design apparatus 100, the design supporting apparatus 200, the recycle proportion calculation apparatus 300, and the recycle information DB 400 may be connected to each other not only via a local area network (LAN) but also via a metropolitan area network (MAN), a wide area network (WAN), a wired network or a wireless network used in the Internet or an intranet, or a composite of the networks.

### Configuration of Design Supporting Apparatus 200

With reference to FIG. 1, a description will be made of functional configurations of the design supporting apparatus 200 to which the present exemplary embodiment is applied.

The design supporting apparatus 200 comprises a design drawing information acquisition unit 210, a design change location specifying unit 220, a recycle information acquisition unit 230, a recycle determination unit 240, a determination result information acquisition unit 250, and a determination result information output unit 260. Here, the design drawing information acquisition unit 210 and the design change location specifying unit 220 are an example of a change recognition unit, and the recycle information acquisition unit 230 is an example of an acquisition unit. The recycle determination unit 240, the determination result information acquisition unit 250, and the determination result information output unit 260 is an example of an output unit.

The design drawing information acquisition unit 210 acquires information regarding a design drawing created by the designer from the design apparatus 100. Herein, the designer performs a design change of the product, and thus design drawing information includes information regarding a design drawing before the design change and information regarding a design drawing after the design change.

The design change location specifying unit 220 extracts a difference between the pieces of information regarding the design drawings before and after the design change, acquired by the design drawing information acquisition unit 210, and specifies the difference as a design change location.

The recycle information acquisition unit 230 retrieves recycle information which is information regarding a recycle process related to the design change (design change location) in a recycle line from recycle information accumulated in the recycle information DB 400 on the basis of the design change location specified by the design change location specifying unit 220, and acquires the recycle information. The recycle information related to the design change is information regarding a recycle process of a recycle line in which the current product before the design change is recycled, and is information regarding a recycle process related to a design change portion. The information will be described later in detail.

Here, the recycle determination unit 240 acquires information (design change location information) regarding the design change location specified by the design change location specifying unit 220 and the recycle information related to the design change location acquired by the recycle information acquisition unit 230, and determines whether or not the product after the design change is within a range in which a recycle treatment can be performed in the current recycle line. Here, the design change location information is an example of change information regarding a design change of a product.

Regarding a determination result in the recycle determination unit 240, for example, in a case where the product after the design change is within a range in which a recycle treatment can be performed in the current recycle line, and a recycle proportion is not reduced due to the design change, “copable and recycle proportion maintained” is determined. In a case where the product after the design change is within a range in which a recycle treatment can be performed in the current recycle line, and a recycle proportion is reduced due to the design change, “copable and recycle proportion reduced” is determined. In a case where the product after the design change is not within a range in which a recycle treatment can be performed in the current recycle line, “non-copable” is determined. A case where “non-copable” is determined is a case where the product after the design change exceeds a boundary of a range in which a recycle treatment can be performed in the current recycle line.

The determination result information acquisition unit 250 acquires information regarding a determination result of whether or not a recycle treatment on the product after the design change is within a copable range with the current recycle line, from the recycle determination unit 240. The determination result information acquisition unit 250 acquires information regarding a recycle proportion of the product from the recycle proportion calculation apparatus 300 in a case where a recycle treatment on the product after the design change is within a copable range with the current recycle line. Among pieces of information regarding a determination result, information indicating a recycle treatment cannot be coped with by the current recycle line is an example of non-copable information, and information indicating that a recycle treatment can be coped with by the current recycle line, and a recycle proportion is reduced due to a design change is an example of reduction information.

The determination result information output unit 260 outputs the information regarding the determination result acquired by the determination result information acquisition unit 250, to the design apparatus 100.

### Configuration of Design Apparatus 100

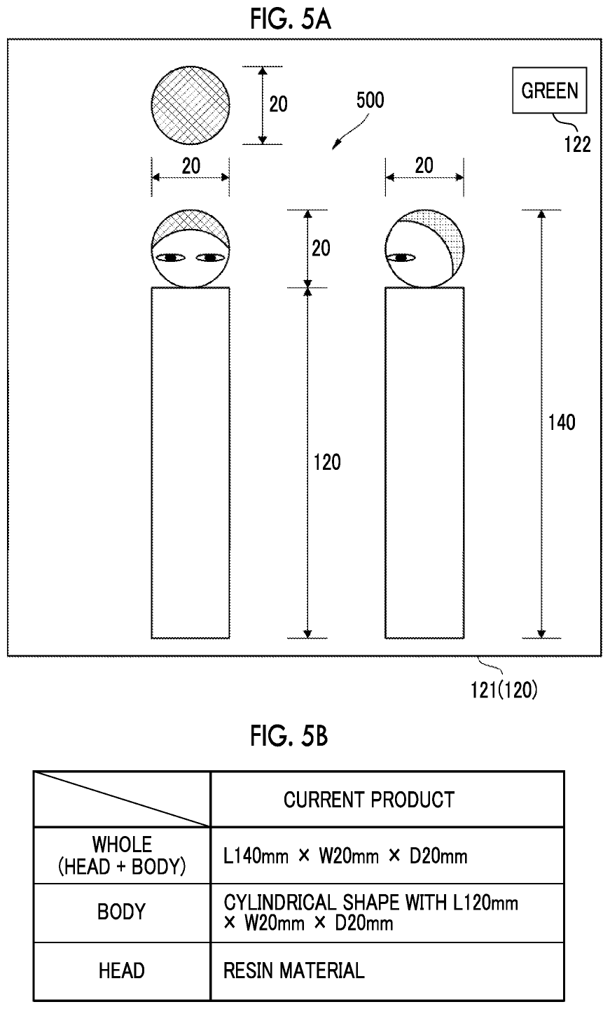

The design apparatus 100 displays the determination result on the display device 120 on the basis of the information regarding the determination result acquired from the determination result information output unit 260. The determination result may be indicated by a color of a determination result display box (a determination result display region 122 in a display screen 121 illustrated in FIG. 5A or the like which will be described later) provided in a display screen (the display screen 121 illustrated in FIG. 5A or the like which will be described later) on which a design drawing after the design change is displayed. For example, a recycle treatment in a recycle line being “copable and recycle proportion maintained” may be displayed green, a recycle treatment in a recycle line being “copable and recycle proportion reduced” may be displayed yellow, a recycle treatment in a recycle line being “non-copable” may be displayed red. The determination result is displayed in a color is displayed on the display screen of the display device 120 along with a design drawing on which the design change is to be performed, and thus the designer can easily recognize the determination result. The determination result may be displayed to be arranged with the design drawing, and may be displayed to overlap the design drawing. The determination result may be displayed not only in a color but also in text or in a sound. A combination thereof may be used.

The designer visually recognizes the determination result displayed on the display device 120, and thus understands whether or not the product after the performed design change is within a range in which a recycle treatment can be coped with by the current recycle line. In a case where “non-copable” is determined for the design change, the designer can perform a design change again such that “copable” is determined by performing a new design change. In other words, it is possible to understand whether or not a design change is within a copable range without rebuilding a recycle line in a stage before the design change is completed. Consequently, it is possible to prevent the occurrence of a situation in which a design change is not within a copable range with the current recycle line in a stage in which a product starts to be subjected to a recycle treatment after the design change is completed.

The designer visually recognizes the determination result displayed on the display device 120, and thus understands whether or not a recycle proportion of the product is reduced in a case where the performed design change is within a copable range with the current recycle facility. In a case where it is determined that a recycle proportion of the product is reduced, the designer can perform a design change again such that a recycle proportion is not reduced by performing a new design change.

Here, a description will be made of a timing at which the design supporting apparatus 200 is used.

In a case where the designer performs design change work, the designer may give an instruction (input of information) for requesting a determination to the design apparatus 100 at a timing at which the designer wants to know the determination of whether or not a design change desired to be performed is within a copable range with the current facility. In this case, design drawing information before and after the design change is sent from the design apparatus 100 to the design supporting apparatus 200. Consequently, the design supporting apparatus 200 outputs a determination result for the design change performed on the basis of the acquired design drawing information.

The design supporting apparatus 200 may acquire a design change performed in the design apparatus 100, that is, design drawing information before and after the design change at a predefined timing, and may output a determination result for the performed design change. The predefined timing is a timing at which, for example, the designer changes apart of the design drawing before the design change. The determination result for the performed design change is output at a timing at which the designer changes a part of the design drawing before the design change, and thus a rework amount required for the designer to perform a design change again is reduced.

The predefined timing may be a timing which is set at a predefined time interval, a timing at which there is no operation at a predefined time after the designer performs a series of design change operations, a timing at which the designer preserves a file regarding a design drawing, or the like. As mentioned above, the design supporting apparatus 200 acquires design drawing information at a predefined timing, and outputs a determination result, and thus a rework amount required for the designer to perform a design change again is reduced. In a case of the timing at which the designer preserves a file regarding a design drawing, the designer will understand a determination result when the designer opens the file next. Even in this case, in a case where the designer understands a determination result before the designer completes a design change, a rework amount required for the designer to perform a design change again is reduced.

### Hardware Configuration

FIG. 2 is a diagram for explaining an example of a hardware configuration of the design supporting apparatus 200. As described above, the design supporting apparatus 200 is configured with a computer.

The design supporting apparatus 200 comprises a CPU 21, a ROM 22, a RAM 23, an HDD 24, a communication input/output interface (communication IF) 25, an input/output interface (input/output IF) 26, a display device 27 connected to the input/output IF 26, an input device 28 connected to the input/output IF 26, and a bus 29. The design supporting apparatus 200 may not comprise the display device 27 and/or the input device 28.

The ROM 22 is a nonvolatile memory which holds stored (written) data even in a case where there is no supply of power. The ROM 22 is, for example, an EPROM, EEPROM, or a flash memory. The ROM 22 stores application software (program) for causing the computer to operate as the design supporting apparatus 200, and data such as initial values of constants or variables used for the program.

The RAM 23 is a volatile memory in which stored data is lost in a case where power is not supplied. The RAM 23 is faster in reading and writing of data than the ROM 22. The RAM 23 is, for example, a DRAM. The RAM 23 is used as a work area in which the program or the data stored in the ROM 22 is read and is developed in an executable state, and data for operating the design supporting apparatus 200 is stored.

The HDD 24 is a rewritable nonvolatile memory which holds stored data even in a case where there is no supply of power, and stores a large volume of data. In the same manner as ROM 22, the HDD 24 may store application software (program) for causing the computer to operate as the design supporting apparatus 200, and data such as initial values of constants or variables used for the program.

The bus 29 is connected to the CPU 21, the ROM 22, the RAM 23, the HDD 24, the communication IF 25, and the input/output IF 26, and allows a program or data to be input and output under the control of the CPU 21.

The communication IF 25 is an interface between the design supporting apparatus 200, and the design apparatus 100 and the recycle proportion calculation apparatus 300. The communication IF 25 functions as the design drawing information acquisition unit 210 which acquires drawing information, the determination result information acquisition unit 250 which acquires information regarding a recycle proportion calculated by the recycle proportion calculation apparatus 300, and the determination result information output unit 260 which outputs a determination result.

The input/output IF 26 is connected to the display device 27 and the input device 28. The display device 27 is a display such as an LCD on which a drawing is visually recognized as an image. The input device 28 is a device used to give an instruction to the CPU 21, and is a keyboard, a mouse, a touch panel, or the like. The design supporting apparatus 200 may not comprise the display device 27 and/or the input device 28.

In a case where power is supplied, the CPU 21 reads the program or the data stored in the ROM 22 (or the HDD 24), and develops the program or the data on the RAM 23 in an executable state. The program is executed. Due to the execution of the program, data is exchanged with the HDD 24, the communication IF 25, and the input/output IF 26.

In the above description, the ROM 22, the RAM 23, and the HDD 24 are provided, and any of the ROM 22, the RAM 23, and the HDD 24 may be configured with a rewritable nonvolatile memory. As the rewritable nonvolatile memory, a flash memory or the like may be used. The ROM 22 and the RAM 23 may be configured integrally with the CPU 21. In this case, the ROM 22 and the RAM 23 may be configured with rewritable nonvolatile memories. As the rewritable nonvolatile memories, flash memories or the like may be used.

In the above description, the design supporting apparatus 200 operates as a computer which is an apparatus processing information according to the application software (program) held in the ROM 22 or the HDD 24. In this case, the respective units (the design change location specifying unit 220, the recycle information acquisition unit 230, and the recycle determination unit 240) of the design supporting apparatus 200 illustrated in FIG. 1 are configured according to the application software (program) developed in an executable form on the RAM 23, and thus the function of the design supporting apparatus 200 is realized.

As described above, the design apparatus 100 operated by the designer also has the same hardware configuration as the hardware configuration illustrated in FIG. 2. The display device 120 connected to the design apparatus 100 corresponds to the display device 27 in FIG. 2, and the input device 130 connected to the design apparatus 100 corresponds to the input device 28 in FIG. 2.

As described above, in a case where the function of the design supporting apparatus 200 is incorporated into the design apparatus 100 as application software, the application software for realizing the function of the design supporting apparatus 200 is held in the ROM 22 or the HDD 24 along with the application software for realizing the function of the design apparatus 100. The application software for realizing the function of the recycle proportion calculation apparatus 300 may be incorporated into the design supporting apparatus 200. The application software for realizing the function of the design supporting apparatus 200 and the function of the recycle proportion calculation apparatus 300 may be incorporated into the design apparatus 100.

The HDD 24 may also have the function of the recycle information DB 400.

### Recycle Information Recorded in Recycle Information DB 400

Recycle information which is information regarding a recycle process of performing a recycle treatment on a product is recorded in the recycle information DB 400. The recycle information includes information regarding a target of each recycle process of performing a recycle treatment on a product (current product) before a design change, information regarding work performed on the current product in each recycle process, and information regarding a copable range in each recycle process. In the following description, a range of a size or a material of a copable product or component in each recycle process will be referred to as a “copable range”.

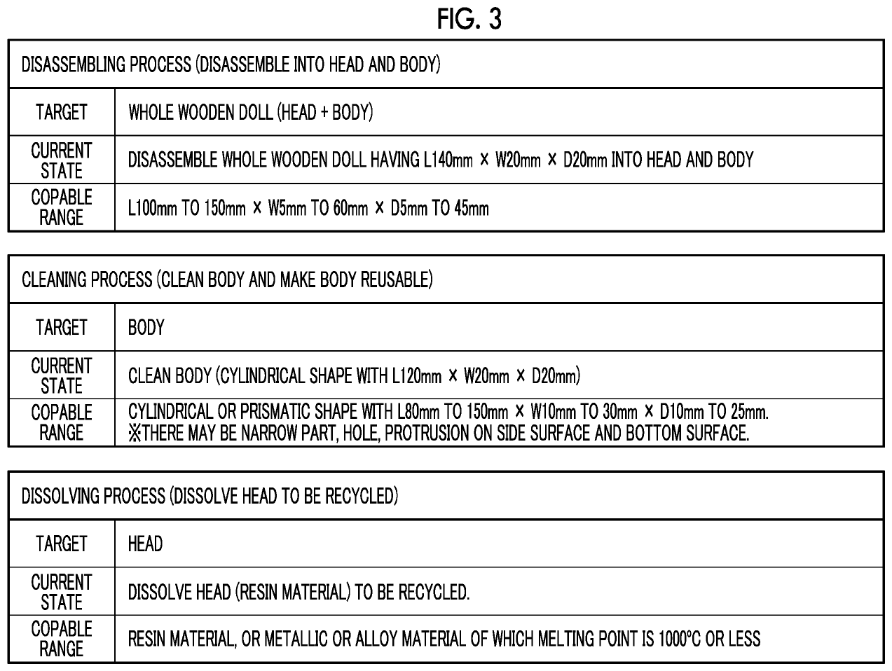

FIG. 3 is a diagram illustrating an example of recycle information recorded in the recycle information DB 400. FIG. 3 illustrates the recycle information recorded in the recycle information DB 400 in a table form. Herein, as an example, a product is a “wooden doll” having a head and a body, and a recycle process in a recycle line is assumed to include three processes such as a disassembling process, a cleaning process, and a dissolving process. A separate facility performing each process is provided for each of the disassembling process, the cleaning process, and the dissolving process. The “wooden doll” which is a product will be described later as an Example.

As illustrated in FIG. 3, the disassembling process is a process of disassembling the whole wooden doll into the head and the body, and a target of the disassembling process is the whole wooden doll.

With respect to a product (current product) before a design change, the whole wooden doll having the length of L140 mm, the width of W20 mm, and the depth of D20 mm is disassembled into the head (the length of L20 mm, the width of W20 mm, and the depth of D20 mm) and the body (the length of L120 mm, the width of W20 mm, and the depth of D20 mm).

A copable range of a size of the whole wooden doll which can be disassembled in the disassembling process is the length of L100 mm to 150 mm, the width of W5 mm to 60 mm, and the depth of D5 mm to 45 mm.

The cleaning process is a process in which the body disassembled in the disassembling process is cleaned to be reusable, and a target of the cleaning process is the body of the wooden doll.

With respect to the product (current product) before the design change, the body of the wooden doll, which is a disassembling result in the disassembling process, has a cylindrical shape with the length of L120 mm, the width of W20 mm, and the depth of D20 mm, and does not have a narrow part, a hole, or a protrusion on a side surface and a bottom surface thereof, and is cleaned.

A copable range of a size of the body of the wooden doll which can be cleaned in the cleaning process is formed in a cylindrical shape or a prismatic shape with the length of L80 mm to 150 mm, the width of W10 mm to 30 mm, and the depth of D10 mm to 25 mm. The body of the wooden doll may have a narrow part, a hole, or a protrusion on the side surface and the bottom surface thereof.

The dissolving process is a process in which the head which is a disassembling result in the disassembling process is dissolved to be recycled, and a target of the dissolving process is the head of the wooden doll.

With respect to the product (current product) before the design change, the head of the wooden doll made of a resin material is dissolved to be recycled.

A copable range of a material which can be recycled by dissolving the head of the wooden doll in the dissolving process is a resin material, or a metallic or alloy material of which a melting point is 1000° C. or less.

### Flowchart

Next, a description will be made of an operation of the design system 1 according to a flowchart. Herein, the description will be made focusing on operations of the design supporting apparatus 200 and the recycle proportion calculation apparatus 300.

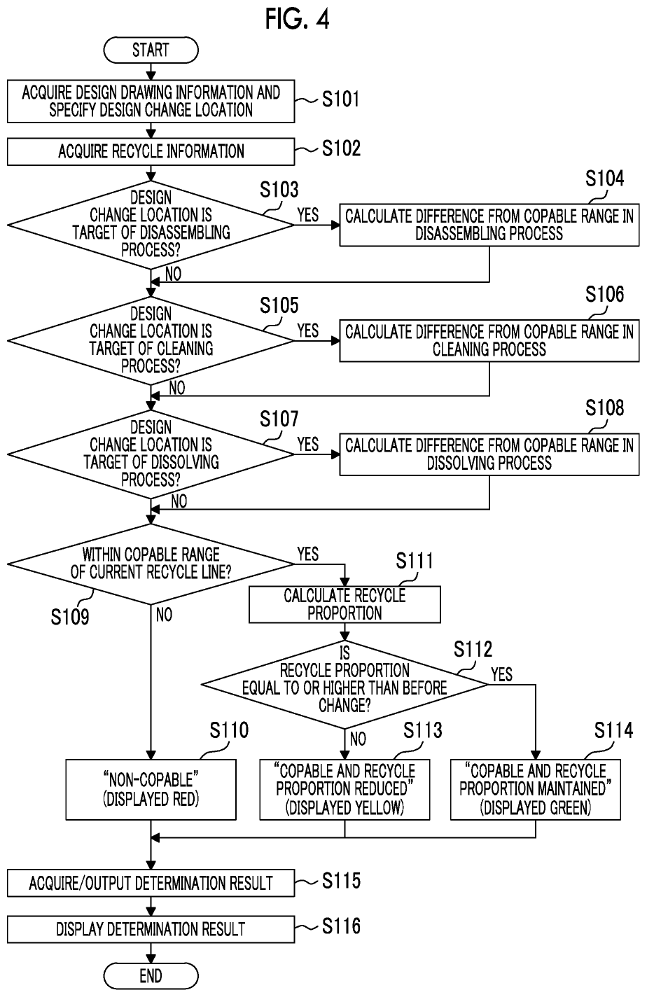

FIG. 4 is a flowchart for explaining an operation of the design system 1 in a case where a product is a “wooden doll” having a head and a body, and facilities for the disassembling process, the cleaning process, and the dissolving process are provided in a recycle line for the product.

Hereinafter, the flowchart in FIG. 4 will be described while referring to the design system 1 illustrated in FIG. 1.

First, the design drawing information acquisition unit 210 of the design supporting apparatus 200 acquires design drawing information from the design apparatus 100, and the design change location specifying unit 220 specifies a design change location (step S101 which is indicated by S101 in FIG. 4; the same applies hereinafter).

The recycle information acquisition unit 230 acquires recycle information for a recycle process of performing a recycle treatment on the product before the design change from the recycle information DB 400 (step S102).

Next, the recycle determination unit 240 determines whether or not the design change location is a target of the disassembling process on the basis of the design change location information specified by the design change location specifying unit 220 and the recycle information acquired by the recycle information acquisition unit 230 (step S103). In this example, it is determined whether the design change location is the head or the body of the wooden doll.

In a case where a determination result in step S103 is affirmative (YES), that is, in a case where the design change location is a target of the disassembling process, the recycle determination unit 240 calculates a difference between the design change location and a copable range in the disassembling process (step S104).

On the other hand, in a case where a determination result in step S103 is negative (NO), that is, in a case where the design change location is not a target of the disassembling process, it is determined whether or not the design change location is a target of the cleaning process (step S105). In this example, it is determined whether or not the design change location is the body of the wooden doll.

In a case where a determination result in step S105 is affirmative (YES), that is, in a case where the design change location is a target of the cleaning process, the recycle determination unit 240 calculates a difference between the design change location and a copable range in the cleaning process (step S106).

On the other hand, in a case where a determination result in step S105 is negative (NO), that is, in a case where the design change location is not a target of the cleaning process, it is determined whether or not the design change location is a target of the dissolving process (step S107). In this example, it is determined whether or not the design change location is the head of the wooden doll.

In a case where a determination result in step S107 is affirmative (YES), that is, in a case where the design change location is a target of the dissolving process, the recycle determination unit 240 calculates a difference between the design change location and a copable range in the dissolving process (step S108).

Next, the recycle determination unit 240 determines whether or not a recycle treatment on the product after the design change is within a copable range of the current recycle line on the basis of the difference from the copable range in the disassembling process, calculated in step S104, the difference from the copable range in the cleaning process, calculated in step S106, and the difference from the copable range in the dissolving process, calculated in step S108 (step S109).

In a case where a determination result in step S109 is negative (NO), that is, in a case where it is determined that a recycle treatment on the product after the design change cannot be coped with by the current recycle line, the recycle determination unit 240 determines “non-copable” (step S110).

On the other hand, in a case where a determination result in step S109 is affirmative (YES), that is, in a case where it is determined that a recycle treatment on the product after the design change can be coped with by the current recycle line, the recycle proportion calculation apparatus 300 calculates a recycle proportion of the product after the design change (step S111).

The recycle determination unit 240 of the design supporting apparatus 200 acquires the recycle proportion calculated in step S111, and determines whether or not the recycle proportion of the product after the design change is equal to or higher than a recycle proportion of the product before the design change (step S112).

In a case where a determination result in step S112 is negative (NO), that is, in a case where it is determined that the recycle proportion of the product after the design change is lower than the recycle proportion of the product before the design change, the recycle determination unit 240 determines “copable and recycle proportion reduced” (step S113).

On the other hand, in a case where a determination result in step S112 is affirmative (YES), that is, in a case where it is determined that the recycle proportion of the product after the design change is equal to or higher than the recycle proportion of the product before the design change, the recycle determination unit 240 determines “copable and recycle proportion maintained” (step S114).

Next, the determination result information acquisition unit 250 acquires determination result information which is information regarding the determination result is acquired, and the determination result information output unit 260 outputs the determination result information to the design apparatus 100 (step S115).

The determination result which is output to the design apparatus 100 is displayed in colors in a determination result display region (a determination result display region 122 of the display screen 121 illustrated in FIG. 5A or the like which will be described later) provided in a display screen (the display screen 121 illustrated in FIG. 5A) of the display device 120 (step S116). Displayed colors are illustrated along with determination results in steps S110, S113, and S114.

### Specific Example

Next, the present exemplary embodiment will be described in more detail by using a specific example with a “wooden doll” having a head and a body as a product.

### Current Product

FIGS. 5A and 5B are diagrams for explaining a wooden doll 500 which is the current product for which a recycle line is already built. FIG. 5A illustrates three orthographic views displayed on the display screen 121 of the display device 120, and FIG. 5B illustrates a shape, a material, and the like of the wooden doll 500 which is the current product. The three orthographic views in FIG. 5A correspond to a design drawing of the wooden doll 500, and are a front view, a side view, and a top view. The unit of a dimension is mm. The determination result display region 122 is provided in the display screen 121 of the display device 120 as illustrated in FIG. 5A.

As illustrated in FIG. 5A, the wooden doll 500 has a spherical head and a cylindrical body. As illustrated in FIG. 5B, the wooden doll 500 has the length of L140 mm, the width of W20 mm, and the depth of D20 mm as the entire size. The body has a cylindrical shape with the length of L120 mm, the width of W20 mm, and the depth of D20 mm. A material forming the head is a resin material.

A design change is not performed on the current product, and thus “green” indicating “copable and recycle proportion maintained” for a recycle treatment in a recycle line is displayed in the determination result display region 122.

### Design Change 1

Next, it is assumed that a design change is performed on the wooden doll 500, and thus a wooden doll 510 is designed.

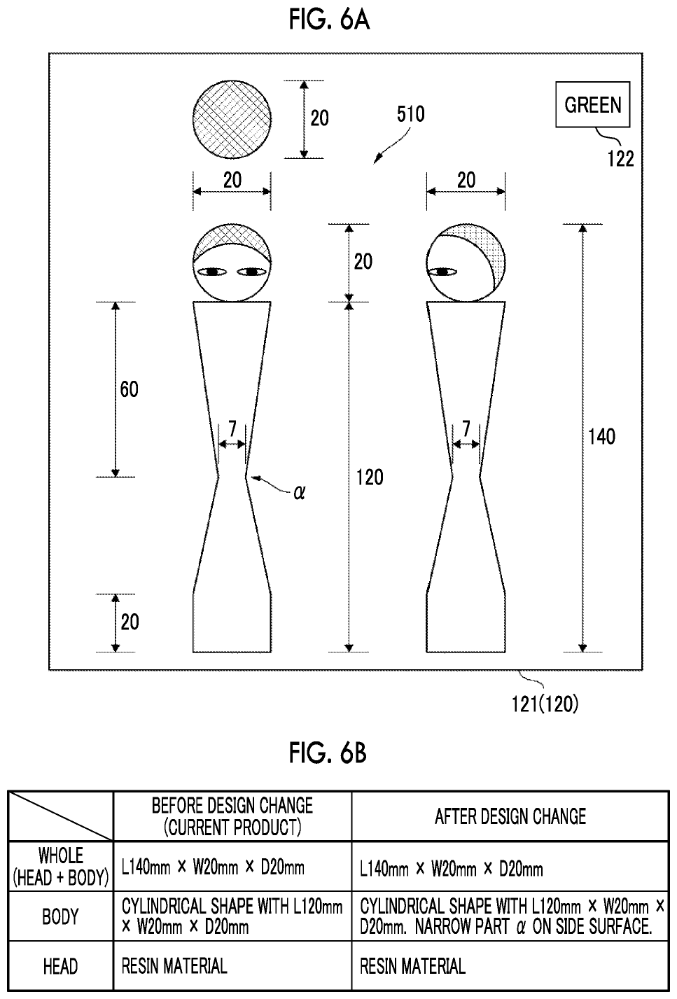

FIGS. 6A and 6B are diagrams for explaining the wooden doll 510 having undergone the design change. FIG. 6A illustrates three orthographic views displayed on the display screen 121 of the display device 120, and FIG. 6B illustrates shapes, materials, and the like of the wooden dolls 500 and 510 before and after the design change. The three orthographic views in FIG. 6A correspond to a design drawing of the wooden doll 510, and are a front view, a side view, and a top view. The unit of a dimension is mm.

As illustrated in FIG. 6A, the wooden doll 510 after the design change has a shape of the body which is different from that of the wooden doll 500 before the design change. In other words, the wooden doll 510 after the design change has a cylindrical body which has a narrow part α at the center of the side surface in the longitudinal direction. In this case, the design change location specifying unit 220 specifies that a design change location is the shape of the body on the basis of a difference between the design drawings in FIGS. 5A and 6A (step S101 in FIG. 4). The body is a target of the disassembling process and the cleaning process, and thus the recycle determination unit 240 compares the shape of the body with the copable ranges in the disassembling process and the cleaning process (step S104 and step S106).

Next, the recycle determination unit 240 determines whether or not a recycle treatment on the wooden doll 510 after the design change is within a copable range in the current recycle line on the basis of a comparison result (step S109). In this case, the entire size of the wooden doll 510 including the body having the narrow part α on a side surface thereof and the size of the body are included in the copable ranges in the disassembling process and the cleaning process, and thus the recycle determination unit 240 performs an affirmative determination, so that the recycle proportion calculation apparatus 300 calculates a recycle proportion (step S111). In this example, the body of the wooden doll 510 having the narrow part α which is a design change location is not different from the body of the wooden doll 500 before the design change in terms of a reuse method or a reuse destination. Consequently, a recycle proportion of the wooden doll 510 has the same value as that of the wooden doll 500 before the design change, and thus the recycle determination unit 240 determines “copable and recycle proportion maintained” (step S114).

Therefore, the determination result display region 122 provided in the display screen 121 of the display device 120 connected to the design apparatus 100 is maintained to be displayed “green” (step S116).

### Design Change 2

Next, it is assumed that a design change is performed on the wooden doll 500, and thus a wooden doll 520 is designed.

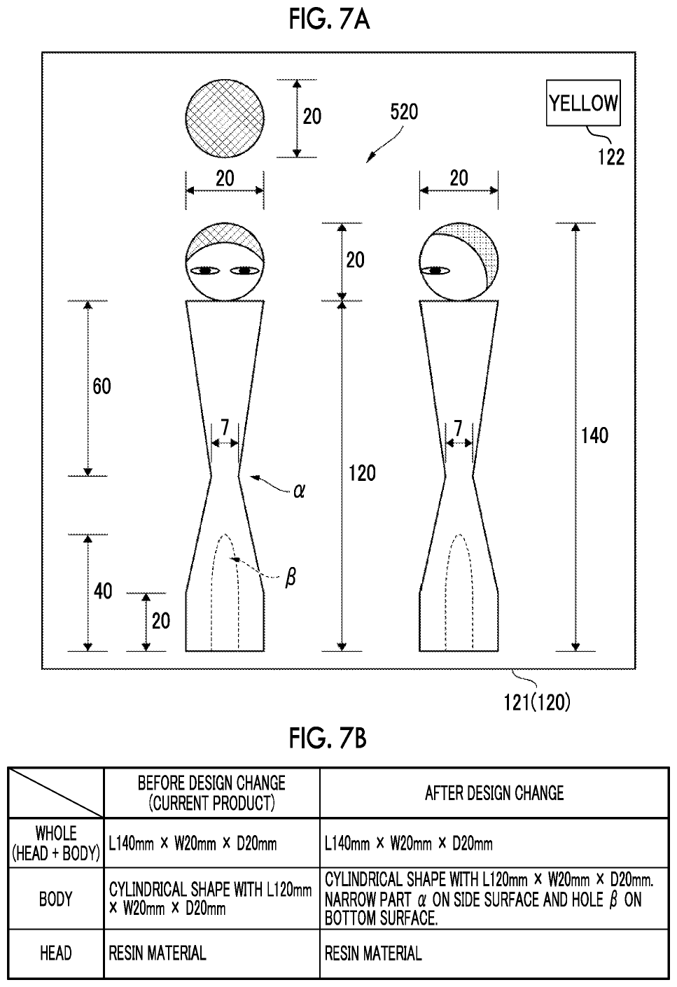

FIGS. 7A and 7B are diagrams for explaining the wooden doll 520 having undergone the design change. FIG. 7A illustrates three orthographic views displayed on the display screen 121 of the display device 120, and FIG. 7B illustrates shapes, materials, and the like of the wooden dolls 500 and 520 before and after the design change. The three orthographic views in FIG. 7A correspond to a design drawing of the wooden doll 520, and are a front view, a side view, and a top view. The unit of a dimension is mm.

As illustrated in FIG. 7A, the wooden doll 520 after the design change has a shape of the body which is different from that of the wooden doll 500 before the design change. In other words, the wooden doll 520 after the design change has a cylindrical body which has a narrow part α at the center of the side surface in the longitudinal direction and also has a recessed hole β on the bottom surface in the longitudinal direction. In this case, the design change location specifying unit 220 specifies that a design change location is the shape of the body on the basis of a difference between the design drawings in FIGS. 5A and 7A (step S101 in FIG. 4). The body is a target of the disassembling process and the cleaning process, and thus the recycle determination unit 240 compares the shape of the body with the copable ranges in the disassembling process and the cleaning process (step S104 and step S106).

Next, the recycle determination unit 240 determines whether or not a recycle treatment on the wooden doll 520 after the design change is within a copable range in the current recycle line on the basis of a comparison result (step S109). In this case, the entire size of the wooden doll 520 including the body having the narrow part α on a side surface thereof and the hole β on a bottom surface thereof and the size of the body are included in the copable ranges in the disassembling process and the cleaning process, and thus the recycle determination unit 240 performs an affirmative determination, so that the recycle proportion calculation apparatus 300 calculates a recycle proportion (step S111). In this example, the body of the wooden doll 520 having the narrow part α and the hole β which are design change locations has a restriction in a reuse destination compared with the body of the wooden doll 500 before the design change. Consequently, a recycle proportion of the wooden doll 520 is calculated to be lower than that of the wooden doll 500 before the design change, and thus the recycle determination unit 240 determines “copable and recycle proportion reduced” (step S113).

Therefore, the determination result display region 122 provided in the display screen 121 of the display device 120 connected to the design apparatus 100 is changed from “green” to “yellow” (step S116).

### Design Change 3

Next, it is assumed that a design change is performed on the wooden doll 500, and thus a wooden doll 530 is designed.

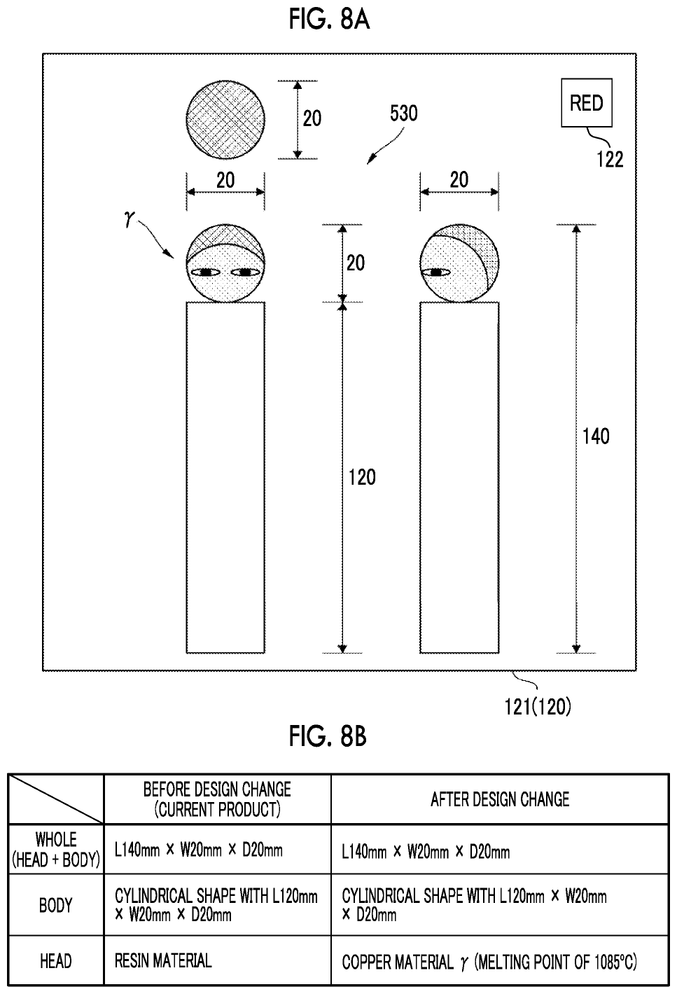

FIGS. 8A and 8B are diagrams for explaining the wooden doll 530 having undergone the design change. FIG. 8A illustrates three orthographic views displayed on the display screen 121 of the display device 120, and FIG. 8B illustrates shapes, materials, and the like of the wooden dolls 500 and 530 before and after the design change. The three orthographic views in FIG. 8A correspond to a design drawing of the wooden doll 530, and are a front view, a side view, and a top view. The unit of a dimension is mm.

As illustrated in FIGS. 8A and 8B, the wooden doll 530 after the design change has a material of the head which is different from that of the wooden doll 500 before the design change. In other words, in the wooden doll 530 after the design change, a material of the head is a copper material γ which is a metallic material instead of the resin material. In this case, the design change location specifying unit 220 specifies that a design change location is a material of the head on the basis of a difference between the design drawings in FIGS. 5A and 8A (step S101 in FIG. 4). Since the head is a target of the dissolving process, the recycle determination unit 240 compares the material of the head with the copable range in the dissolving process (step S108).

Next, the recycle determination unit 240 determines whether or not a recycle treatment on the wooden doll 530 after the design change is within a copable range in the current recycle line on the basis of a comparison result (step S109). In this case, a melting point of the copper material γ which is a material of the head of the wooden doll 530 is 1085° C. exceeding 1000° C. which is a copable range in the dissolving process, and is not within the copable range in the dissolving process. Therefore, the recycle determination unit 240 determines “non-copable” (step S110).

Therefore, the determination result display region 122 provided in the display screen 121 of the display device 120 connected to the design apparatus 100 is changed from “green” to “red” (step S116).

### Design Change 4

Next, it is assumed that a design change is performed on the wooden doll 500, and thus a wooden doll 540 is designed.

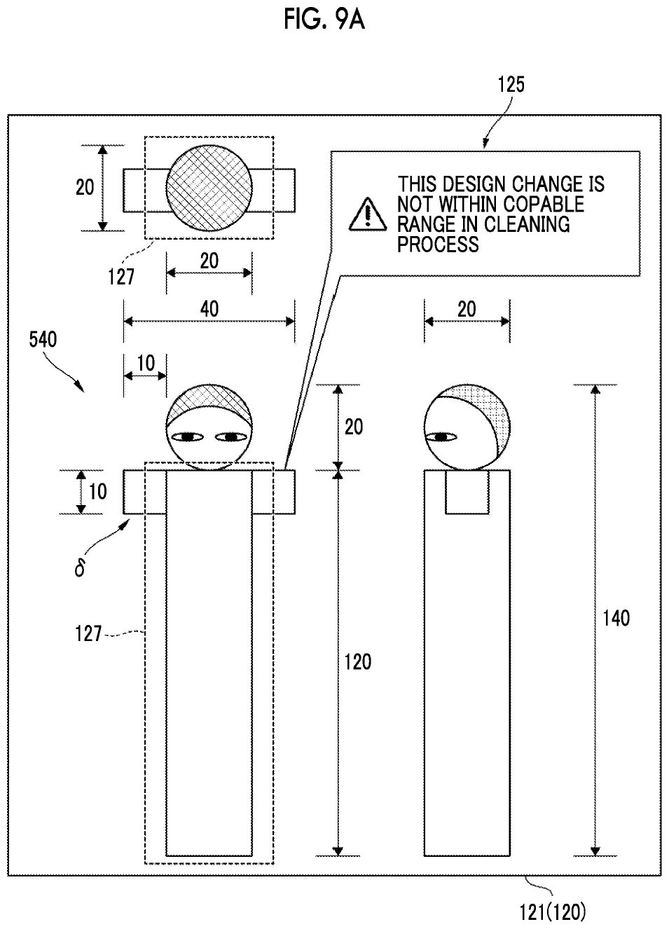

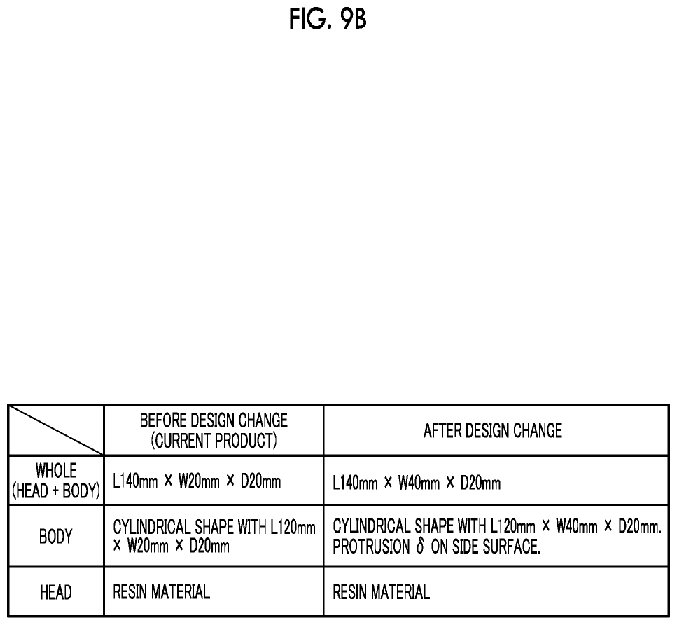

FIGS. 9A and 9B are diagrams for explaining the wooden doll 540 having undergone the design change. FIG. 9A illustrates three orthographic views displayed on the display screen 121 of the display device 120, and FIG. 9B illustrates shapes, materials, and the like of the wooden dolls 500 and 540 before and after the design change. The three orthographic views in FIG. 9A correspond to a design drawing of the wooden doll 540, and are a front view, a side view, and a top view. The unit of a dimension is mm.

As illustrated in FIG. 9A, the wooden doll 540 after the design change has a shape of the body which is different from that of the wooden doll 500 before the design change. In other words, the wooden doll 540 after the design change has a cylindrical body which has a protrusion δ protruding to both sides in a width direction at an upper part of the side surface. In this case, the design change location specifying unit 220 specifies that a design change location is the shape of the body on the basis of a difference between the design drawings in FIGS. 5A and 9A (step S101 in FIG. 4). The body is a target of the disassembling process and the cleaning process, and thus the recycle determination unit 240 compares the shape of the body with the copable ranges in the disassembling process and the cleaning process (step S104 and step S106).

Next, the recycle determination unit 240 determines whether or not a recycle treatment on the wooden doll 540 after the design change is within a copable range in the current recycle line on the basis of a comparison result (step S109). In this case, the entire size of the wooden doll 540 including the body having the protrusion δ on a side surface thereof is included in the copable range in the disassembling process. On the other hand, in a size of the body of the wooden doll 540, the width W exceeds 30 mm which is an upper limit of the copable range in the cleaning process, and is not within the copable range in the cleaning process. Thus, the recycle determination unit 240 determines “non-copable” (step S110).

Therefore, the display screen 121 of the display device 120 connected to the design apparatus 100 is displayed to correspond to “non-copable” which is a determination result.

In this example, the determination result “non-copable” is displayed as the content that “this design change is not within the copable range in the cleaning process” in a pop-up window 125, and thus the recycle process which is “not copable” in the recycle line is displayed. The pop-up window 125 indicates the protrusion δ which is a design change location not within a copable range in the cleaning process.

FIG. 9A illustrates a region 127 in which a recycle treatment can be performed on the product after the design change in the recycle line. Consequently, it becomes easier for the designer to change design such that it is determined that the recycle treatment “can be coped with” by using the region 127 as a reference.

As described above, by using the design supporting apparatus 200, in a design stage before a design change is completed, information indicating whether or not a recycle treatment on a product after the design change to be performed is within a copable range in the current recycle line is output. In a case where the recycle treatment is within a copable range in the current recycle line, information indicating whether or not a recycle proportion is reduced is output.

The program may cause a computer to function as an acquisition unit that acquires recycle information regarding a recycle process of a product, a change recognition unit that recognizes change information regarding a design change of the product, and an output unit that outputs non-copable information in a case where a recycle treatment on a product after the design change cannot be coped with by the recycle process on the basis of the recycle information and the change information. In this case, the program may be stored on a storage medium so as to be provided, and may be provided by communication means. In this case, the invention may be understood as a “non-transitory computer readable medium storing the program”.

The “non-transitory computer readable medium storing the program” indicates a computer readable recording medium recording the program, used to install or execute the program or to distribute the program.

The recording medium includes a digital versatile disk (DVD) based on standards defined by DVD forums, a compact disk (CD), a Blu-ray (registered trademark) disk, a magnetooptical disk (MO), a flexible disk (FD), a magnetic tape, an HDD, a ROM, and a flash memory.

As mentioned above, the exemplary embodiment of the present invention has been described. Various modifications or alternations of configurations without departing from the scope of the technical spirit of the present invention are included in the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition unit that acquires recycle information regarding a recycle process of a product;
a change recognition unit that recognizes change information regarding a design change of the product; and
an output unit that outputs non-copable information in a case where a recycle treatment on a product after the design change is not able to be coped with by the recycle process on the basis of the recycle information and the change information.

2. The information processing apparatus according to claim 1,
wherein the acquisition unit acquires the recycle information regarding a plurality of the recycle processes, and
wherein the output unit specifies a recycle process related to the design change among the plurality of recycle processes on the basis of the change information, and outputs the non-copable information in a case where the specified recycle process is not able to cope with the recycle treatment on the product after the design change.

3. The information processing apparatus according to claim 2,
wherein the output unit outputs information regarding the specified recycle process which is not able to cope with the recycle treatment on the product after the design change.

4. The information processing apparatus according to claim 3,
wherein the output unit outputs information regarding the design change related to the specified recycle process.

5. The information processing apparatus according to claim 1, further comprising:
a calculation unit that calculates a recycle proportion of the product after the design change in a case where the recycle treatment on the product after the design change is able to be coped with by the recycle process,
wherein, in a case where the recycle proportion of the product after the design change is reduced more than before the design change, the output unit outputs reduction information indicating that the recycle proportion is reduced.

6. The information processing apparatus according to claim 5, further comprising:
a display unit that displays, in different aspects, the non-copable information in a case where the recycle treatment on the product after the design change is not able to be coped with by the recycle process and the reduction information in a case where the recycle treatment on the product after the design change is able to be coped with by the recycle process and the recycle proportion of the product after the design change is reduced more than before the design change.

7. The information processing apparatus according to claim 1, further comprising:
a design drawing creation unit that creates a design drawing of a product,
wherein, in a case where there is a difference between a drawing before the design change and a drawing after the design change in the design drawing creation unit, the change recognition unit recognizes the difference as the change information.

8. The information processing apparatus according to claim 7, further comprising:
a display unit that displays the drawing after the design change,
wherein the output unit outputs the non-copable information such that the display unit displays the non-copable information along with the drawing after the design change.

9. The information processing apparatus according to claim 1,
wherein the acquisition unit acquires, as the recycle information, information regarding a copable range in the recycle process, and
wherein the output unit outputs the non-copable information in a case where a change of the product exceeds the copable range.

10. A non-transitory computer readable medium storing a program causing a computer to realize:
a function of acquiring recycle information regarding a recycle process of a product;
a function of recognizing change information regarding a design change of the product; and
a function of outputting non-copable information in a case where a recycle treatment on a product after the design change is not able to be coped with by the recycle process on the basis of the recycle information and the change information.

11. An information processing apparatus comprising:
acquisition means for acquiring recycle information regarding a recycle process of a product;
change recognition means for recognizing change information regarding a design change of the product; and
output means for outputting non-copable information in a case where a recycle treatment on a product after the design change is not able to be coped with by the recycle process on the basis of the recycle information and the change information.
